(19) United States
(12) Patent Application Publication
(10) Pub. No.: US 2019/0313803 A1
(43) Pub. Date: Oct. 17, 2019

(54) COLOR-CHANGEABLE LIGHTING SYSTEM FOR FURNITURE

(71) Applicants: CHIH HSIUNG LIU, Benoni (ZA); Mei Jun Xu, Jiujiang (CN); Li Ming Chen, Changzhou (CN); Xiao Ping Ran, Xichong (CN)

(72) Inventors: CHIH HSIUNG LIU, Benoni (ZA); Mei Jun Xu, Jiujiang (CN); Li Ming Chen, Changzhou (CN); Xiao Ping Ran, Xichong (CN)

(21) Appl. No.: 15/953,413

(22) Filed: Apr. 14, 2018

(51) Int. Cl. A47C 7/72; F21V 33/00; H05B 33/08; H05B 37/02

(52) U.S. Cl. CPC A47C 7/725; H05B 37/0272; H05B 33/0857; F21V 33/0012

(57) ABSTRACT

The present invention relates to a color-changing lighting system for use in connection with lounger or reclined chairs commonly used to furnish home offices, libraries, family rooms, living rooms, dens, and the like, wherein the lighting system is operatively connected to different sections of the chair for selectively changing the color of the emitted light as desired in order to provide the particular room, within which the furniture is located, with a selectively desirable ambiance or environment. The system comprises a plurality of RGB LEDs located at strategic locations upon the chair, a control box, and a mobile or remote controller for communicating with the control box in order to selectively command the control box to issue voltage signals to the various RGB LEDs so as to achieve desired resulting colors.

### FIELD OF THE INVENTION

The present invention relates generally to lighting systems used in connection with furniture, such as, for example, but not limited to, lounge chairs commonly used to furnish home offices, libraries, family rooms, living rooms, dens, and the like, and more particularly to a new and improved lighting system operatively connected to the furniture for selectively changing the color of the emitted light as desired in order to provide the particular room, within which the furniture is located, with a selectively desirable ambiance or environment.

### BACKGROUND OF THE INVENTION

Studies have shown that the colors in a particular room of one's home or office are a direct reflection of one's personality and preferences, and conversely, the colors in a particular room of one's home or office can influence one's thoughts and moods. Different colors have been shown to have different effects upon one's mood and emotions such as, for example, effectively inducing a peaceful or harmonious environment within a particular room. Light colors effectively convey the feeling of expansiveness or openness, thereby effectively making particular rooms feel larger and brighter. Dark colors tend to convey feelings of sophistication and warmth, thereby effectively rendering relatively large rooms more intimate. Red, for example, is a very unique color in that it is very intense, it tends to draw people together, and it tends to stimulate conversation, but in a relatively light environment, as when a room is lit by natural daylight, it can sometimes feel somewhat overpowering or overwhelming, whereas in a relatively dark environment, as when a room is lit by artificial light, it can feel somewhat muted and elegant. Yellow is another interesting color in that it effectively embodies the joy of sunshine and conveys the feeling of happiness. However, again, in large amounts, yellow light can lead to feelings or moods of frustration or depression. Blue is yet another interesting color. Light blue hues can engender feelings of calmness, whereas dark blue hues can evoke feelings of sadness. The color green is considered to be the most restful to the human eye. Utilizing green hues tends to evoke calmness, it effectively relieves stress and helps people to relax, and exhibits warmth to promote comfort and togetherness. Purple is still yet another interesting color in that in its darkest hues, it is dramatically rich and sophisticated, and is readily associated with wealth and luxury, while in its lighter hues, such as, for example, lavender or lilac, it promotes restfulness, similar to those feelings one would derive from light blue hues but with more warmth. Accordingly, it has been found that when furnishing a particular room with particular furniture, such as, for example, a lounger, a recliner, or a similar type chair, and particularly when the lounger, recliner, or similar chair is electrically powered for controlling, for example, an adjustable headrest, an adjustable footrest, an adjustable lumbar support, and an adjustable inclination or reclining system wherein portions of the chair can be tilted or reclined to one or more positions, it is desirable to be able to control the lighting within the room in order to effectively achieve any one or more of the previously noted colored lighting environments. If the chair is not an electrically powered type chair, then it may still be desirable to effectively incorporate an electrical control system for the room lighting into a particular chair.

A need therefore exists in the art for a new and improved piece of furniture. Another need exists in the art for a new and improved piece of furniture, such as, for example, a lounger, recliner, or similar chair, wherein the same is provided with lighting, the color of which can be selectively changed as desired in order to achieve a selectively colored environment or ambiance within a particular room within which the piece of furniture is located. Still another need exists in the art for a new and improved piece of furniture, such as, for example, a lounger, recliner, or similar chair, wherein the chair is manually adjustable and yet can be provided with a plurality of light sources incorporated within or operatively associated with the structure or framework of the chair at selectively strategic locations, and wherein the color of the light sources can be selectively changed as desired. An additional need exists in the art for a new and improved piece of furniture, such as, for example, a lounger, recliner, or similar chair, wherein the chair is an electrically powered chair provided with a plurality of light sources incorporated within the structure or framework of the chair at selectively strategic locations, and wherein the color of the light sources can be selectively changed as desired. A further need exists in the art for a new and improved piece of furniture, such as, for example, a lounger, recliner, or similar chair, wherein the chair is an electrically powered chair provided with a plurality of light sources incorporated within the structure or framework of the chair at selectively strategic locations, and wherein the color of the light sources can be selectively changed as desired by means of a hand-held remote control device. Yet another need exists in the art for a new and improved piece of furniture, such as, for example, a lounger, recliner, or similar chair, wherein the chair is an electrically powered chair provided with a plurality of light sources incorporated within the structure or framework of the chair at selectively strategic locations, wherein the color of the light sources can be selectively changed as desired by means of a hand-held remote control device, and wherein the hand-held remote control device comprises a smart phone or similar electronic device. A yet further need exists in the art for a new and improved piece of furniture, such as, for example, a lounger, recliner, or similar chair, wherein the chair is an electrically powered chair provided with a plurality of light sources incorporated within the structure or framework of the chair at selectively strategic locations, wherein the color of the light sources can be selectively changed as desired by means of a smart phone or similar electronic device having an APP incorporated within the smart phone or similar electronic device whereby, as a result of the smart phone or similar electronic device being connected to the central control box of the electrically powered chair by means of wireless communication technology, the person seated in the chair can utilize the APP upon the smart phone or similar electronic device to selectively control the color of the light sources incorporated within the chair.

### OVERALL OBJECTIVES OF THE PRESENT INVENTION

An overall objective of the present invention is to provide a new and improved piece of furniture. Another overall objective of the present invention is to provide a new and improved piece of furniture, such as, for example, a lounger, recliner, or similar chair, wherein the same is provided with lighting, the color of which can be selectively changed as desired in order to achieve a selectively colored environment or ambiance within a particular room within which the piece of furniture is located. Still another overall objective of the present invention is to provide a new and improved piece of furniture, such as, for example, a lounger, recliner, or similar chair, wherein the chair is manually adjustable and yet can be provided with a plurality of light sources incorporated within or operatively associated with the structure or framework of the chair at selectively strategic locations, and wherein the color of the light sources can be selectively changed as desired. An additional overall objective of the present invention is to provide a new and improved piece of furniture, such as, for example, a lounger, recliner, or similar chair, wherein the chair is an electrically powered chair provided with a plurality of light sources incorporated within the structure or framework of the chair at selectively strategic locations, and wherein the color of the light sources can be selectively changed as desired. A further overall objective of the present invention is to provide a new and improved piece of furniture, such as, for example, a lounger, recliner, or similar chair, wherein the chair is an electrically powered chair provided with a plurality of light sources incorporated within the structure or framework of the chair at selectively strategic locations, and wherein the color of the light sources can be selectively changed as desired by means of a hand-held remote control device. Yet another overall objective of the present invention is to provide a new and improved piece of furniture, such as, for example, a lounger, recliner, or similar chair, wherein the chair is an electrically powered chair provided with a plurality of light sources incorporated within the structure or framework of the chair at selectively strategic locations, wherein the color of the light sources can be selectively changed as desired by means of a hand-held remote control device, and wherein the hand-held remote control device comprises a smart phone or similar electronic device. A yet further overall objective of the present invention is to provide a new and improved piece of furniture, such as, for example, a lounger, recliner, or similar chair, wherein the chair is an electrically powered chair provided with a plurality of light sources incorporated within the structure or framework of the chair at selectively strategic locations, wherein the color of the light sources can be selectively changed as desired by means of a smart phone or similar electronic device having an APP incorporated within the smart phone or similar electronic device whereby, as a result of the smart phone or similar electronic device being connected to the central control box of the electrically powered chair by means of wireless communication technology, the person seated in the chair can utilize the APP upon the smart phone or similar electronic device to selectively control the color of the light sources incorporated within the chair.

### SUMMARY OF THE INVENTION

The foregoing needs are met, and the foregoing objectives are achieved, in accordance with the principles and teachings of the present invention through means of a color-changeable lighting system which comprises a central control box and a plurality of light sources which are strategically mounted upon or incorporated within the structural framework of a piece of furniture, such as, for example, a lounger, recliner, or similar type of chair conventionally found within an office, a home office, a home library, a home living room, a home den, a home study, a home family room, and the like. If the chair is an electrically powered chair, wherein the central control box already controls various adjustable structural components of the electrically powered chair, such as, for example, an adjustable headrest, an adjustable footrest, an adjustable lumbar support mechanism, or the mechanism for tilting or reclining the chair to any one of several tilt or reclined positions, then the central control box can also be electrically connected to the plurality of light sources.

The plurality of light sources comprise LEDs and may be mounted upon or incorporated within the chair cup holders, an LED light bar, or a single LED bulb. The LEDs would comprise red, green, and blue LEDs whereby various combinations of the same, both in wavelength and frequency, would be controlled so as to ultimately achieve the desired light color emitted by the LEDs into the room. In addition, the various control signals to be transmitted to the central control box may be sent by means of wireless communication between a mobile device, such as, for example, a smart phone, tablet, or other similar device. Still further, the smart phone, tablet, or other similar device may have an APP downloaded thereon which is utilized to control the wireless communications to the central control box. Alternatively, the various control signals can be transmitted from other types of portable, hand-held devices, such as, for example, the remote control for a television. In the instance that the chair is not an electrically powered chair, but a manually powered chair, the chair may have a central control box, and the plurality of light sources mounted thereon, and again, one's smart phone, tablet, or other similar device, or alternatively, the television remote control can be utilized to transmit appropriate signals for controlling the wavelength and frequency characteristics of the LEDs in order to generate the desired color for the particular room.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a schematic diagram illustrating a first embodiment of the present invention wherein, for example, a mobile communication device is wirelessly connected to the central control box of an electrically powered chair such that various different LED colored lights, operatively associated with cup holders mounted upon or incorporated within the arm portions of the chair, a light bar mounted upon a particularly desirable portion of the chair, or separate LED colored lights mounted upon a particularly desirable portion of the chair, can be controlled by means of the mobile communication device which is provided with a suitable APP for controlling signals to be transmitted to the central control box by means of the wireless communication established between the mobile communication device and the central control box such that the central control box will, in turn, transmit suitable voltage signals to the various different LED colored lights in order to obtain a resulting color for the environment or ambiance within the room within which the electrically powered chair is located;

FIG. 2 is a schematic diagram illustrating a second embodiment of the present invention wherein, for example, in lieu of utilizing a mobile communication device wirelessly connected to the central control box of the electrically powered chair, the hand-held remote control device can be utilized in a manner similar to that of the mobile communication device so as to likewise transmit suitable signals to the central control box of the electrically powered chair whereby the central control box will, in turn, transmit suitable voltage signals to the various different LED colored lights in order to obtain a resulting color for the environment or ambiance within the room within which the electrically powered chair is located; and

FIG. 3 is a schematic diagram illustrating a third embodiment of the present invention wherein an electrical control system, similar to that illustrated within FIG. 2, has effectively been adapted for a manually-actuated chair such that a hand-held remote control device can likewise be utilized so as to transmit suitable signals to a central control box, mounted upon the manually actuated chair whereby the central control box will, in turn, transmit suitable voltage signals to the various different LED colored lights mounted upon the chair in order to obtain a resulting color for the environment or ambiance within the room within which the manually actuated chair is located.

### DETAILED DESCRIPTION OF THE ILLUSTRATED EMBODIMENTS

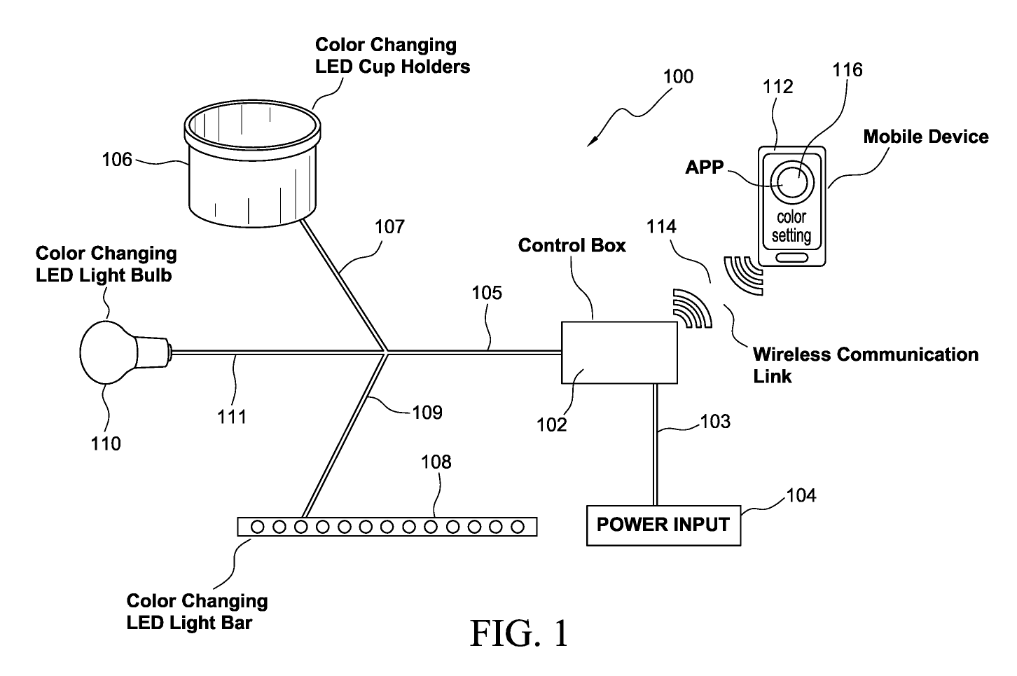

Referring now to the drawings, and more particularly to FIG. 1 thereof, a first embodiment of a new and improved color-changing lighting system, for use in connection with furniture, such as, for example, but not limited to, electrically powered lounger or recliner chairs commonly used to furnish home offices, libraries, family rooms, living rooms, dens, and the like, is disclosed and is generally indicated by the reference character 100. More particularly, as will be appreciated by those who are familiar with electrically-powered lounger or recliner chairs, such chairs are provided with a central control box 102 which receives electrical power from a suitable power input or power source 104 by means of an electrical wire, cable, or conduit 103. As is well known, the central control box 102 of a conventional electrically powered chair is electrically connected to various portions or sections of the electrically powered lounger or chair in order to control, for example, a powered headrest, a powered footrest, a powered lumbar support mechanism, and one or more actuators for causing the electrically powered chair to be tilted, or to have, for example, the back portion or section of the electrically powered chair to be reclined to one or more reclined positions separately or in conjunction with the movement of the adjustable headrest or adjustable footrest. In accordance with the principles and teachings of the present invention, however, the central control box 102 is additionally electrically connected to one or more LED units which comprise multiple LED lights of different colors, wherein such different colors comprise the primary colors of red (R), green (G), and blue (B). As is also well known, when the different ROB lights are effectively combined in various intensities, which are controlled by, or are achieved by, different voltage signals applied to the individual LED lights of a particular color, then other resulting colors are able to be obtained. In accordance with additional principles and teachings of the present invention, the various RGB LEDs may be incorporated within the peripheral or bottom wall portions of one or more cup holders 106 which may be mounted upon or structurally incorporated within, for example, arm portions of the electrically powered chair and which are electrically connected to a main power output cable 105 of the central control box 102 by means of a first electrical connector wire, cable, or conduit 107, one or more light bars 108 which may be mounted upon or incorporated within, for example, various edge portions of the electrically powered chair structure so as to effectively serve as illuminated trim for the electrically powered chair, and which are electrically connected to the main power output cable 105 of the central control box 102 by means of a second electrical connector wire, cable, or conduit 109, and/or one or more single light bulbs 110 which effectively form a cluster of LED lights and which, again, may be mounted upon or incorporated within any structural location of the electrically powered chair and which are electrically connected to the main power output wire, cable, or conduit 105 of the central control box 102 by means of a third electrical connector wire, cable, or conduit 111.

In addition to the aforenoted components comprising the color-changing system 100 of the present invention, a mobile communication device 112 is also provided and is adapted to be in wireless communication with the central control box 102 by means of a wireless communication link 114. The mobile communication device 112 may comprise any suitable mobile communication device, such as, for example, a smart phone, a tablet, or the like, and the mobile communication device is also provided with an APP 116 which comprises various settings, such as, for example, the ability to select a particular color from the choices comprising the RGB set of colors, and in addition, the ability to select varying degrees of voltage values within the range of 0-255 which comprises the range of computer control settings corresponding to particular voltage settings. Selecting a particular computer control setting or value generates a particular voltage signal, characteristic of the particularly selected computer control value, which is then transmitted to the central control box 102 whereupon the central control box will, in turn, transmit the particular voltage signal to the particular one of the RGB LEDs.

As a result of such signals, transmitted to each one of the RGB LEDs, that is, to all of the red (R) LEDs, or to all of the green (G) LEDs, or to all of the blue (B) LEDs, different resulting colors can be achieved so as to, in turn, selectively achieve a particularly colored environment or ambiance, within the particular room within which the electrically powered chair is located, as desired. For example, when the red (R) LEDs and the green (G) LEDs are at their maximum level of 255, while the blue (B) LEDs are at their minimum level of zero, a yellow light, having a color similar to that of a banana, is achieved. As the intensity of the signal transmitted to the blue (B) LEDs is enhanced, the brightness of the resultant yellow light is diminished. For example, increasing the signal to the blue (B) LEDs to 100 results in a soft yellow light, while increasing the signal to the blue (B) LEDs still further to 230 results in a light cream color. Enhancing the signal to the blue (B) LEDs to its maximum of 255 results in the loss of all yellow light and the resulting light will be white, while decreasing all of the signals to all of the red (R) LEDs, to all of the green (G) LEDs, and to all of the blue (B) LEDs to zero, results in black light. In a similar manner, in order to effectively achieve an orange-colored light, the signal transmitted to the red (R) LEDs is maintained at 255, the signal to the blue (B) LEDs is maintained at zero, and the signals to the green (G) LEDs is adjust to a value within the range of 215-230. The lower the signal to the green (G) LEDs, the brighter or more intense or pronounced the resulting orange light will be.

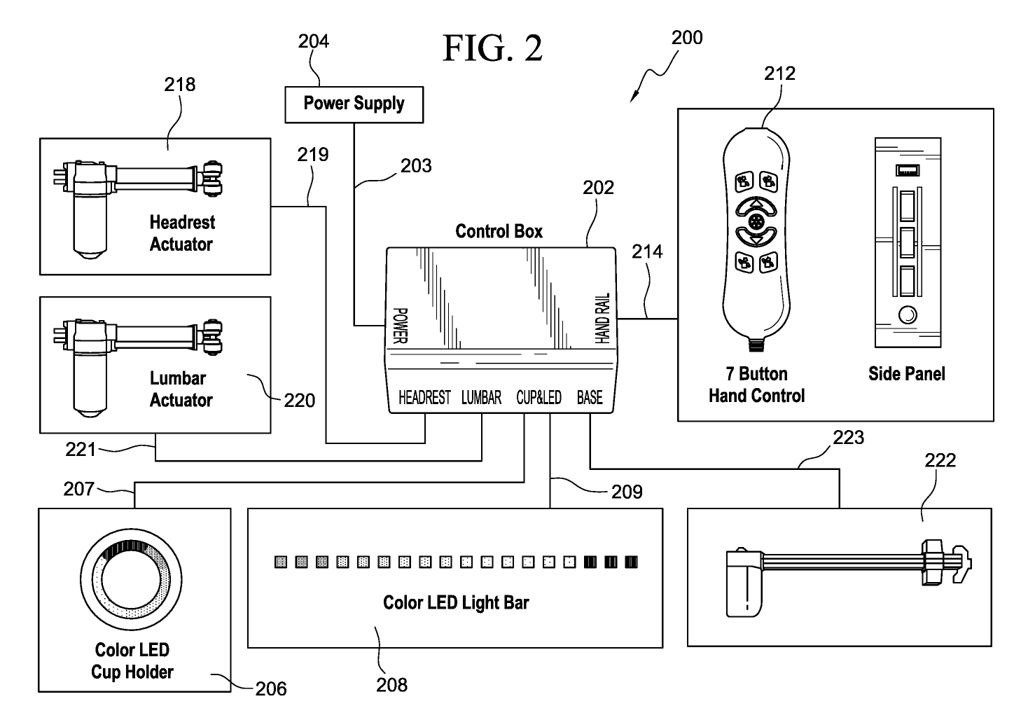

With reference now being made to FIG. 2, there is illustrated a second embodiment of the present invention as generally indicated by the reference character 200. It is to be noted that component parts of this second embodiment system which correspond to component parts of the first embodiment system will be denoted by corresponding reference characters except that they will be within the 200 series. More particularly, FIG. 2 schematically shows the system as being operative in connection with an electrically powered chair which comprises, for example, an adjustable headrest actuator 218 which is electrically connected to the central control box by means of a suitable electrical wire, cable, or conduit 219, an adjustable lumbar support mechanism 220 which is electrically connected to the central control box by means of a suitable electrical wire, cable, or conduit 221, and an an adjustable tilt/recline actuator 222 which is electrically connected to the central control box by means of a suitable electrical wire, cable, or conduit 223. In addition, in lieu of the use of the smart phone, tablet, or the like 112, as illustrated within the first embodiment system 100, the second embodiment system 200 utilizes the hand-held remote control device 212 which is already provided with, for example, a wireless communication link 214 for controlling the various adjustable components of the electrically powered chair, such as, for example, the headrest 218, the lumbar actuator 220, and the chair tilt/recline actuator 222. The hand-held remote control device 212 can be readily modified so as to effectively incorporate therein a suitable control module, similar to the APP 116 of the smart phone, tablet, or the like 112, so as to likewise send suitable control signals to the central control box 202 in order to, in turn, have the central control box 202 transmit suitable voltage signals to the various RGB LEDs mounted upon or incorporated within the cup holders 206, the light bar 208, and the like.

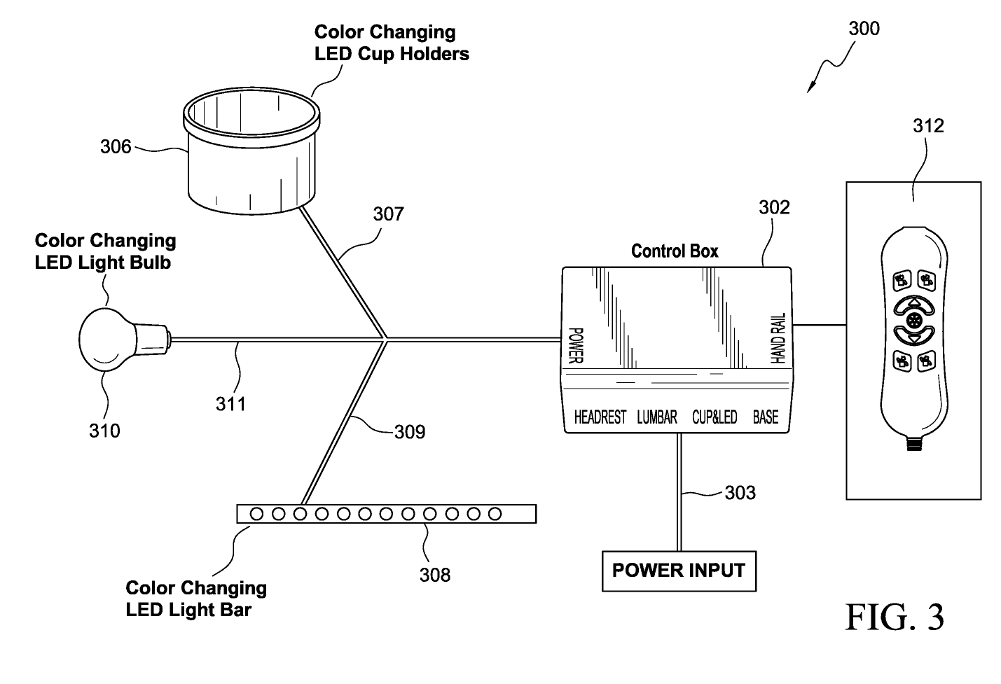

With reference lastly being made to FIG. 3, a third embodiment of the present invention is disclosed and is generally indicated by the reference character 300. As was the case with the second embodiment system of the present invention 200, it is to be noted that component parts of this third embodiment system which correspond to component parts of the first and second embodiment systems will be denoted by corresponding reference characters except that they will be within the 300 series. More particularly, FIG. 3 schematically shows the system as being operative in connection with a manually adjustable chair. In view of the fact that the chair, with which this third embodiment system of the present invention is to be operative, is a manually adjustable chair, the color-changeable system 300 is effectively an add-on system which can be mounted or installed upon the manually adjustable chair. As such, the various components comprising the system 300 are substantially the same as those illustrated within FIG. 1 which disclosed the first embodiment system except for the fact that in lieu of the mobile communication device, smart phone, tablet, or the like 112, a hand-held remote control implement or device 312 can be employed. This remote control implement or device can be similar to the remote control implement or device 212 utilized in connection with the second embodiment system illustrated within FIG. 2, or it can be a remote control implement or device such as is conventionally used for watching TV, with the necessary controls characteristic of the color-changeable system of the present invention added on to the TV remote control implement or device, or still further, the remote control device or implement 312 can in fact be a smart phone, tablet, or the like, having an APP, similar to the APP 116, downloaded thereon.

Obviously, many variations and modifications of the present invention are possible in light of the above teachings. It is therefore to be understood that within the scope of the appended claims, the present invention may be practiced otherwise than as specifically described herein.

What is claimed is:

1. A color-changeable lighting system for use upon a lounger or recliner chair disposed within a room for imparting to the room a selectively desirable color in order to provide the room with a selective colored environment or ambiance, comprising:
a plurality of LED lights comprising at least one red (R) LED light, at least one green (G) LED light, and at least one blue (B) LED light installed upon the lounger or recliner chair at at least one location upon the lounger or recliner chair;
a central control box mounted upon the lounger or recliner chair and electrically connected to said plurality of LED lights comprising said at least one red (R) LED light, at least one green (G) LED light, and at least one blue (B) LED light so as to transmit individual voltage signals to each one of said at least one red (R) LED light, at least one green (G) LED light, and at least one blue (B) LED light of said plurality of LED lights such that, depending upon the strength of said voltage signals transmitted individually to said at least one red (R) LED light, at least one green (G) LED light, and at least one blue (B) LED light of said plurality of LED lights, a resulting light color will illuminate the room within which the lounger or recliner chair is located; and
a hand-held device having a control mechanism incorporated therein, and wirelessly connected to said central control box, for controlling the levels of said voltage signals to be transmitted by said central control box to each individual red (R) LED light, green (G) LED light, and blue (B) LED light so as to in fact achieve the desired light color for the room within which the lounger or recliner chair is located.

2. The system as set forth in claim 1, wherein:
said plurality of of LED lights comprising said at least one red (R) LED light, at least one green (G) LED light, and at least one blue (B) LED light are located within at least one cup holder mounted upon or incorporated within an arm portion of the lounger or recliner chair.

3. The system as set forth in claim 1, wherein:
said plurality of of LED lights comprising said at least one red (R) LED light, at least one green (G) LED light, and at least one blue (B) LED light are located within at least one light bar which is mounted upon or incorporated within a portion of the lounger or recliner chair so as to effectively serve as illuminated trim of the lounger or recliner chair.

4. The system as set forth in claim 1, wherein:
said plurality of of LED lights comprising said at least one red (R) LED light, at least one green (G) LED light, and at least one blue (B) LED light comprise a cluster of LED lights which are mounted upon or incorporated within at least one portion of the lounger or recliner chair.

5. The system as set forth in claim 1, wherein:
said hand-held device comprises a device selected from the group comprising a smart phone, tablet, and the like; and
said control mechanism incorporated within said hand-held device comprises an APP downloaded to said hand-held device, wherein said APP comprises computer control settings within the range of 0-255 which effectively control signals transmitted to said central control box so as to control the strength of individual voltage signals transmitted from said central control box to said at least one red (R) LED light, at least one green (G) LED light, and at least one blue (B) LED light in order to achieve the resulting color from said at least one red (R) LED light, at least one green (G) LED light, and at least one blue (B) LED light in order to illuminate the room within which the lounger or recliner chair is disposed.

6. The system as set forth in claim 1, wherein:
the lounger or recliner chair comprises an electrically powered lounger or recliner chair provided with a hand-held device for controlling the movement of predetermined sections of the electrically powered chair; and
said hand-held device comprises the hand-held device of the electrically powered chair for controlling the movement of predetermined sections of the electrically powered chair.

7. The system as set forth in claim 1, wherein:
the lounger or recliner chair comprises a manually adjustable lounger or recliner chair;
said plurality of LED lights comprising said at least one red (R) LED light, at least one green (G) LED light, and at least one blue (B) LED light are installed upon the manually adjustable lounger or recliner chair;
said central control box is installed upon said manually adjustable lounger or recliner chair; and
said hand-held device comprises a remote control device.

8. The system as set forth in claim 7, wherein:
said remote control device is a modified TV remote control device so as to include said control mechanism therewithin.
